(19) United States
(12) Patent Application Publication
(10) Pub. No.: US 2008/0309668 A1
(43) Pub. Date: Dec. 18, 2008

(54) Image processing method and apparatus

(76) Inventor: Igor Borovikov, Foster City, CA (US)

Correspondence Address: Ralph A. Dowell of DOWELL & DOWELL P.C., 2111 Eisenhower Ave, Suite 406, Alexandria, VA, 22314, US

(21) Appl. No.: 11/798,935

(22) Filed: May 17, 2007

(51) Int. Cl. G06T 15/10

(52) U.S. Cl. 345/427

(57) ABSTRACT

A plurality of items of panorama data are prepared and associated with a plurality of coordinates in a three-dimensional space. The data represent distant view as viewed from the respective coordinates. When a camera is located at a coordinate not associate with the panorama data, background data representing a distant view as viewed from a camera coordinate is generated by synthesizing two or more items of panorama data.

### BACKGROUND OF THE INVENTION

1. Field of the Invention

The present invention relates to a three-dimensional computer graphics technology and, more particularly, to a technology of drawing a background object mapped behind a three-dimensional object as a distant view.

2. Description of the Related Art

Three-dimensional computer graphics are used in various fields including movies, animation and games. With an increase in the speed of arithmetic processors, graphics with increasingly higher definition are produced. Recently, image processing that gives “true-to-life” impression is even possible.

In order to produce more realistic images in three-dimensional computer graphics, a background should be drawn behind three-dimensional objects.

Drawing a background by using three-dimensional objects requires an enormous amount of computing.

### SUMMARY OF THE INVENTION

In this perspective, a general purpose of the present invention is to provide a technology of reducing the amount of computation in drawing a background.

The image processing method according to at least one embodiment of the present invention relates to an image processing method for three-dimensional graphics. In this image processing method, panorama data representing distant views as viewed from respective coordinates are prepared in association with at least two coordinates in a three-dimensional space. When a camera is located at a coordinate not associated with panorama data, background data representing a distant view as viewed from the coordinate of the camera (hereinafter, simply referred to as a camera coordinate) is produced by synthesizing panorama data prepared in advance. The background data thus generated is used as a background when rendering a three-dimensional object placed in its place.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a three-dimensional space to be drawn;

FIG. 2 shows a first synthesizing process for synthesizing panorama data according to an embodiment;

FIG. 3 shows generation of background data by interpolation;

FIG. 4 shows a second synthesizing process for synthesizing panorama data according to an embodiment; and

FIG. 5 shows the structure of an image processing apparatus according to an embodiment.

### DETAILED DESCRIPTION OF THE INVENTION

The invention will now be described by reference to the preferred embodiments. This does not intend to limit the scope of the present invention, but to exemplify the invention.

Embodiments which will be described relate to a drawing technology for three-dimensional graphics and to a technology of generating data used as a background (hereinafter, referred to as background data) in rendering a three-dimensional object placed in a view volume. A summary will be given first.

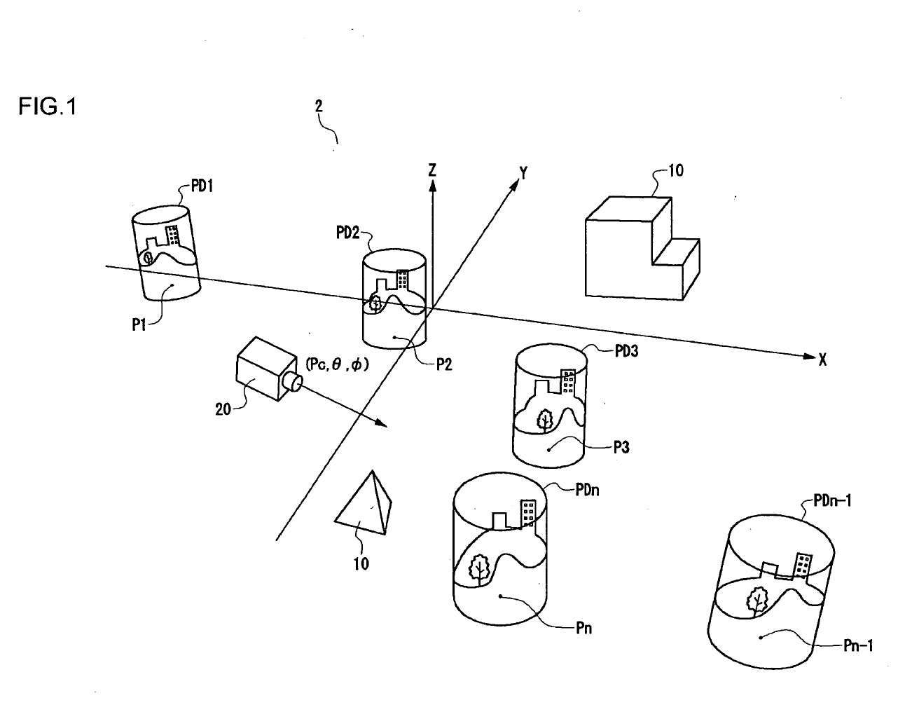

An image processing method according to an embodiment relates to an image processing method for three-dimensional graphics. The method performs the following processes. The processes are mainly shown in FIGS. 1-3.

(1) A plurality of coordinates P1-Pn in a three-dimensional space 2, where n is an integer, are associated with a plurality of items of panorama data PD1-PDn representing distant views as viewed from the coordinates P1-Pn, respectively.

(2) Subsequently, when a camera 20 is located at a coordinate not associated with the panorama data PD, background BGD representing a distant view as viewed from the coordinate Pc of the camera 20 is generated by synthesizing the panorama data PD.

According to this embodiment, a background suited to the position of the camera is generated.

The panorama data PD may hold data for a 360° distant view as viewed from the corresponding coordinate P. Denoting the direction of sight line of a camera as θ (θ indicates a real number) and denoting the viewing angle of the camera as φ (φ indicates a real number), the following process may be performed.

(2-a) First image data GDi is extracted from the first panorama data PDi so as to at least include the viewing angle φ around the direction θ.

(2-b) Second image data GDj is extracted from the second panorama data PDj so as to at least include the viewing angle φ around the direction θ.

(2-c) Matching is computed between the first and second image data GDi and GDj.

(2-d) Interpolation image data between the first image data GDi and the second image data GDj is generated based on the result of matching computation.

(2-e) The interpolation image thus generated is output as background data BGD.

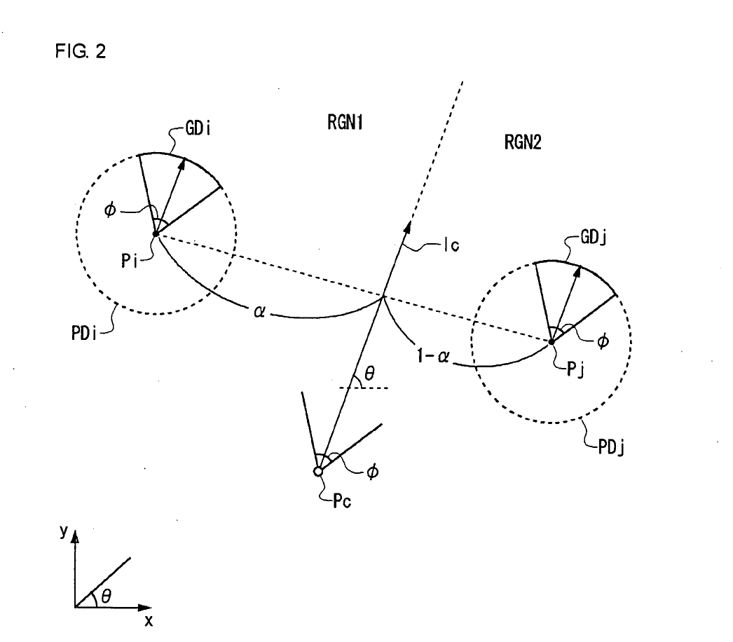

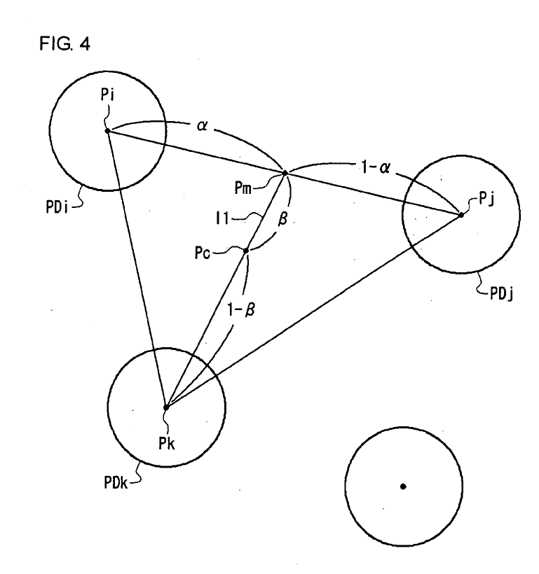

This process is shown in FIG. 2 and FIG. 4.

In generating the background data BGD, the coordinates Pi and PJ may be selected from two regions RGN1 and RGN2 partitioned by a line lc which passes through the camera coordinate Pc and which includes the direction of sight line θ of the camera 20, and the two items of panorama data PDi and PDj associated with the selected coordinates Pi and Pj may be synthesized. This process is mainly shown in FIG. 2.

The following processes may be performed when generating the background data BGD. This process is mainly shown in FIG. 4.

(2-f) A total of m coordinates Pi, Pj and Pk, which form an m-sided polygon (m is an integer equal to or larger than 3) including the coordinate Pc of the camera 20, are selected.

(2-g) A total of m items of panorama data PDi, PDj and PDk associated with the selected coordinates Pi, Pj and Pk are synthesized.

By increasing the number of items of panorama data to be synthesized, it is possible to generate more accurate background data.

A description will now be given of a preferred embodiment of the present invention with reference to the drawings. Like reference characters designate like or corresponding elements, members and processes throughout the views. The description of them will not be repeated for brevity. Reference herein to details of the illustrated embodiments is not intended to limit the scope of the claims. It should be understood that not all of the features and the combination thereof discussed are essential to the invention.

FIG. 1 shows a three-dimensional space 2 to be drawn. The three-dimensional space 2 includes several three-dimensional objects 10 and a plurality of items of panorama data PD1-PDn.

The items of panorama data PD1-PDn are associated with a plurality of coordinates P1-Pn in the three-dimensional space. The panorama data PDo-PDn are data representing distant views as viewed from the coordinates P1-Pn, respectively. In this embodiment, each item of the panorama data PD holds data representing a distant view of 360 degrees (in horizontal viewing angle) as viewed from the corresponding one of the coordinates P1-Pn, respectively. The actual panorama data PD is two-dimensional (v pixels×h pixels) image data in which the X coordinates are associated one to one with the direction of sight line θ. For example, at X=0, a distant view as viewed from the coordinate P in the direction of sight line 0° is drawn. At X=h, a distant view as viewed in the direction of sight line 360° is drawn. That is, a distant view as viewed in the direction of sight line θ=X/h×360° is drawn at an arbitrary X coordinate. For ease of understanding, FIG. 1 shows the panorama data PD as a cylindrical object deformed so that the right and left sides of two-dimensional image data meet. The panorama data PD shown virtually as being cylindrical is not actually placed as a three-dimensional object.

Spherical-surface model data may be used instead of cylindrical data. In this case, the viewing angle may be expressed by a solid angle. When the direction of sight line of a camera is restricted to a certain range, omnidirectional panorama data for 0-360° need not be prepared.

The panorama data PD is prepared as data of JPEG or bit map format. Such panorama data may be generated by using known image processing software to synthesize a plurality of images picked by, for example, a digital still camera, or may be generated in an alternative manner. The panorama data PD may be created using two-dimensional computer graphics for drawing or painting. Alternatively, the data may be generated by modeling three-dimensional objects in a distant view using three-dimensional computer graphics and subjecting the modeled data to projection transform onto a two-dimensional plane.

The camera 20 is provided in a three-dimensional space. The camera 20 is virtually provided and represents a viewpoint in rendering. That is, those of the objects modeled in the three-dimensional space that are included in the field of view of the camera 20 are projected onto the plane and displayed on a display. The coordinate of the camera 20 (hereinafter, simply referred to as a camera coordinate) is denoted by Pc.

According to this embodiment, when the camera 20 is located at a coordinate not associated with the panorama data PD (i.e., when the camera 20 is located at a position other than P1-Pn), the background data BGD representing a distant view as viewed from the coordinate Pc of the camera 20 is generated by synthesizing several items of panorama data. The method of the synthesizing process will be explained hereinafter.

(First Synthesizing Process)

FIG. 2 shows a first synthesizing process for synthesizing panorama data according to an embodiment. FIG. 2 shows a top view seeing the three-dimensional space 2 of FIG. 1 in the negative direction of the Z-axis, i.e., shows an XY plane. According to this embodiment, panorama data PD shall be prepared as cylindrical data, and the direction of sight line θ of the camera 20 shall represent the deflection angle with respect to the X-axis in the XY plane. The viewing angle of the camera 20 will be denoted by φ.

In the first synthesizing process, two items of panorama data PDi and PDj are selected among a plurality of items of panorama data PD1-PDn in order to generate the background data BGD (not shown). Selection of the two items of panorama data PDi and PDj is performed as follows.

First, a line lc, which passes through the coordinate Pc of the camera 20 and lies in the direction of sight line defined by an angle θ of the camera 20, is allowed to divide the space into two regions RGN1 and RGN2. The coordinates Pi and Pj are selected one each from the regions RGN1 and RGN2, respectively. The two items of panorama data associated with the selected coordinates are synthesized (blended). When a plurality of items of panorama data PD are placed in any of the regions RGN1 and RGN2, the panorama data PD closest to the camera coordinate Pc is selected.

Image data GDi is extracted from the panorama data PDi so as to include at least the viewing angle φ around the direction of sight line θ. That is, a range between θ-φ/2 and θ+φ/2 in the X coordinate is extracted from the panorama data PDi (two-dimensional image data). Similarly, image data GDi is extracted from the panorama data PDj so as to at least include the viewing angle φ around the direction of sight line θ. In clipping out data, the viewing angle in the vertical direction may be taken into account. For improvement in matching precision at the ends of an image, an image in the range resulting from adding an angular margin Δφ the actual viewing angle φ is preferably extracted.

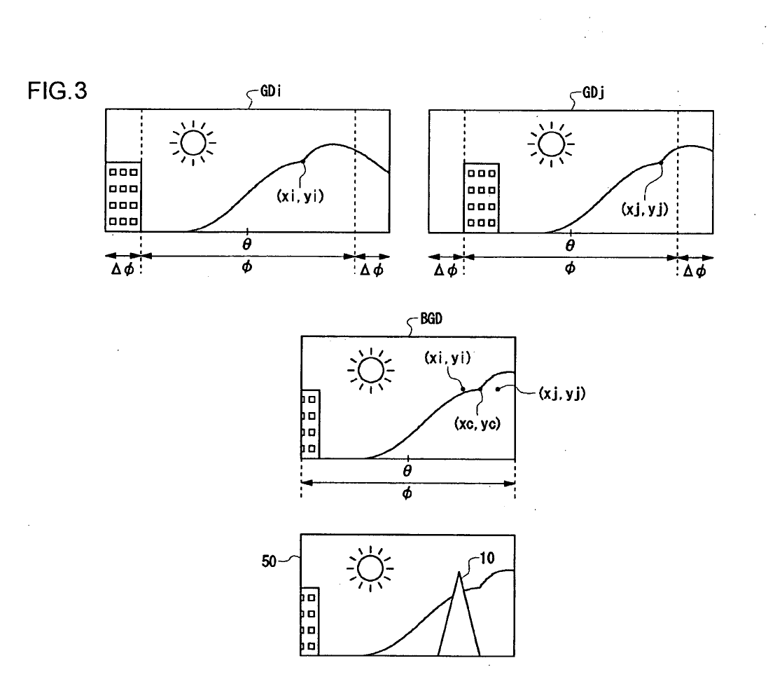

The background data BGD is generated by computing matching between the image data GDi and the image data GDj, and generating interpolation image data between the image data GDi and the image data GDj based on the result of matching. FIG. 3 shows interpolation-based generation of background data and synthesis of the background data and a three-dimensional object.

The image data PD is data representing a distant view as viewed from the coordinate Pi and represents a distant view in the direction of sight line θ and spanning the viewing angle (φ+2Δφ). Similarly, the image data GDj is data representing a distant view as viewed from the coordinate Pj and represents a distant view in the direction of sight line θ and spanning the viewing angle (φ+2Δφ).

Matching is computed between the image data GDi and the image data GDj so as to detect corresponding points or corresponding areas (hereinafter, represented by corresponding points). The data which associates the corresponding points in the image data GDi and GDj with each other is called corresponding point information data. The points (xi, yi) and (xj, yj) on a ridgeline of a mountain are shown in FIG. 3 as examples of corresponding points.

A corresponding point (xc, yc), in a distant view as viewed from the camera 20, corresponding to the corresponding points (xi, yi) and (xj, yj) is placed at a point which internally divides the interval between the corresponding point (xi, yi) in the image data GDi and the corresponding point (xj, yj) in the image data GDj. As shown in FIG. 2, given that a line lc internally divides the line Pi-Pj connecting the coordinates Pi and Pj into α:1−α, interpolation may be performed by using the dividing ratio α. For example, the coordinate (xc, yc) of the corresponding point in the background data BGD may be determined by the following expression.

(xc, yc)=(α−1)*(xi, yi)+α*(xj, yj)

In this example, simple interpolation is performed. Alternatively, the coordinate (xc, yc) may be computed by an expression using another parameter.

The other corresponding points are processed in a similar manner. An interpolation image is generated by interpolating the positions and pixel values of the corresponding points. As a result, the entire background data BGD for the background as viewed from the camera coordinate Pc in the direction θ and spanning the viewing angle φ is generated.

Matching may be computed by any suitable method such as optical flow, block matching, and the method we proposed in Japanese Patent 2927350. Generation of interpolation images based on the result of matching may be according to any suitable method including the method of Japanese Patent 2927350.

An ultimate image 50 displayed on a display is generated by synthesizing the three-dimensional object 10 and the background data BGD. That is, the background data BGD is mapped onto the plane of destination of projection and used as background data in rendering the three-dimensional object. When the z-buffer algorithm is used, the background data is drawn such that the z value is at a maximum. The three-dimensional object 10 is projected onto the same plane of projection such that the z value thereof is smaller than that of the background data. The publicly known technology may be used to perform these image processes.

In order to define the advantage of the embodiment more clearly, a case is assumed where one item of background data is prepared in association with the coordinate system of a certain three-dimensional space. If the direction of movement differs from the direction of sight line of a camera, one would expect that the background should also change with the travel of the camera. In the assumed case, however, there is a problem in that the background does not change because the same background data continues to be used even if the camera moves. When this happens, the viewer of the image may feel awkward about the image.

On the other hand, with the image processing technology according to this embodiment, background data for a background as viewed from a coordinate, for which panorama data is not provided, in an arbitrary direction can be easily generated by preparing several items of panorama data PD.

Further, as the camera coordinate Pc is changed, the background data BGD corresponding to the new camera coordinate is generated accordingly. Thus, as the viewpoint (camera position) moves, the background is changed in association. Therefore, more realistic computer graphics than previously available can be generated.

(Second Synthesizing Process)

In the first synthesizing process, two items of panorama data PDi and PDj are synthesized by way of example. In the second synthesizing process, three or more items of panorama data are synthesized. FIG. 4 shows the second synthesizing process for synthesizing panorama data according to the embodiment. In the example of FIG. 4, three items of panorama data PDi, PDj and PDk are synthesized to generate background data BGD.

In the second synthesizing process, three coordinates forming a triangle (m=3), which includes the camera coordinate Pc, are selected from the coordinates P associated with panorama data PD. When a plurality of triangles including the camera coordinate Pc are selectable, three coordinates may be selected in accordance with any of the following rules or a combination of a plurality of the rules.

1. Selection is made such that the vertices of the triangle are closest to the camera coordinate Pc.

2. Selection is made such that the center of gravity of the triangle formed is closest to the camera coordinate Pc.

3. Selection is made such that the triangle formed is closest to an equilateral triangle.

If rule 1 is to be followed, the three vertices may be selected in the order of closeness to the camera coordinate Pc.

If rule 3 is to be followed, selection may be made such that an evaluation expression (60-θ1)²+(60-θ2)²+(60-θ3)² is at a minimum, where θ1, θ2 and θ3 denote the interior angles of the triangle. Alternatively, given that the three sides of the triangle are denoted by a, b and c, the combination may be selected which minimizes the evaluation expression (a-b)²+(b-c)²+(c-a)² or the expression (a-d)²+(b-d)²+(c-d)², where d=(a+b+c)/3.

The three items of panorama data PDi, PDj and PDk respectively associated with the coordinates Pi, Pj and Pk selected according to at least one of the rules are synthesized.

The three items of panorama data PDi, PDj and PDk may be synthesized as described below. First, a line 11 passing through the coordinates Pk and Pc is caused to internally divide a line Pi-Pj connecting the coordinates Pi and Pj. The intersection of the lines will be referred to as an intermediate coordinate Pm. The process above differs from the process of FIG. 2 in that the line 11 does not have any relevance to the direction of sight line θ. Given that the intermediate coordinate Pm internally divides the line Pi-Pj into α:1−α, intermediate image data GDm is generated by subjecting image data GDi and GDj clipped out from the panorama data PDi and PDj, respectively, to interpolation by using α. For interpolation, the same technique as used in the first synthesizing process may be used.

Subsequently, the intermediate image data GDm and the image data GDk clipped out from the panorama data PDk are synthesized so as to generate background data BGD for the background as viewed from the camera coordinate Pc. For synthesis, the ratio β:1−β into which the camera coordinate Pc divides the line Pm-Pk connecting the coordinates Pm and Pk may be used.

According to this process, the background data BGD more accurate than produced by the process of FIG. 2 can be generated since three items of panorama data PD are used.

When the camera moves outside the selected triangle, it is preferable to maintain the two vertices forming the side crossed by the camera as vertex coordinates of a new triangle and change the other vertex. In this case, the two vertices are maintained even if the camera moves. Therefore, the background data BGD generated by interpolation is prevented from becoming discontinuous.

When the triangle including the camera coordinate is switched (re-selected) in association with the movement of the camera, the background data BGD, produced by synthesizing the panorama data PD at the vertices of the triangle before the switching, may be α blended with the background data BGD produced by synthesizing the panorama data PD at the vertices of the triangle after the switching. Through this process, the background data BGD is prevented from becoming discontinuous as a result of re-selection of a triangle.

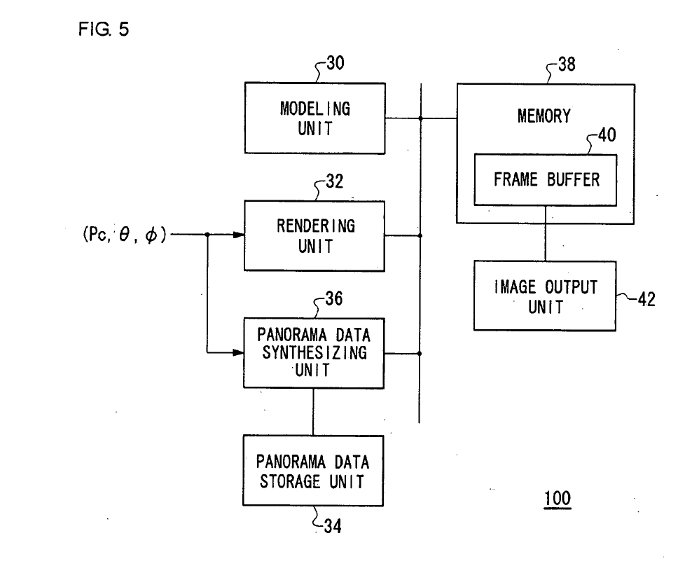

FIG. 5 shows the structure of the image processing apparatus according to the embodiment. The block diagram showing the structure of an image processing apparatus 100 illustrates another embodiment of the present invention. The image processing apparatus 100 may be formed with hardware such as a processor, a computer carrying a memory, a workstation, and a game device.

The image processing apparatus 100 is provided with a modeling unit 30, a rendering unit 32, a panorama data storage unit 34, a panorama data synthesizing unit 36, a memory 38, and an image output unit 42.

The modeling unit 30 is provided with what is called an editor function, and, through an interaction with a user, places a three-dimensional object in a predetermined coordinate system so as to model a three-dimensional space. Vertex data and luminance data of a primitive such as a polygon and a polyhedron generated by modeling are stored in the memory 38.

Through an interaction with a user, the modeling unit 30 defines the coordinate Pc, direction of sight line θ, and viewing angle φ of a virtual camera (hereinafter, referred to as camera parameters) and stores the parameters in the memory 38. When the position and sight line of a camera change with time moment by moment, camera parameters are defined as a function of time. As a result, the path followed as the camera moves (hereinafter, referred to a motion path) is described. In the case of a game program etc., camera parameters are not defined in advance. Instead, the modeling unit 30, rendering an object, may set them up in real time according to the game user's directions.

The rendering unit 32 reads the data for the three-dimensional space modeled by the modeling unit 30 from the memory 38. Further, the rendering unit 32 reads the camera parameters and performs rendering processes, such as projection onto a plane, and hidden surface elimination, based on the parameters thus read.

The panorama data storage unit 34 holds a plurality of items of panorama data PD1-PDn which are associated with a plurality of coordinates P1-Pn in a three-dimensional space and which represent distant views as seen from the respective coordinates. The panorama data storage unit 34 may be formed as an area in the memory 38 or as an area in a hard disk.

The panorama data synthesizing unit 36 receives camera parameters (Pc, θ, φ) and generates background data BGD for the background as viewed from the camera coordinate Pc in the direction θ, by synthesizing several items of panorama data PDs. This process is described above.

The memory 38 includes a frame buffer 40. The background data BGD generated by the panorama data synthesizing unit 36 is written in the frame buffer 40 directly or indirectly. When the z-buffer algorithm is used, the z value of the background data BGD is set to a maximum. The rendering unit 32 writes the data generated as a result of the rendering process in the frame buffer 40. As a result, the data containing the object modeled by the modeling unit 30 and the background data are written in the frame buffer 40.

The image output unit 42 outputs the generated image data to a display (not shown). The output destination of image data is not limited to a display. The image (still image or moving images) generated by the image processing apparatus 100 may be saved in predetermined format such as bit map format, JPEG format, and MPEG (Moving Picture Expert Group) format.

The operation performed when the user (hereinafter, referred to as a programmer) creates three-dimensional graphics using the apparatus of FIG. 5 will now be described.

For example, a programmer may program a car racing game. In this case, a vehicle and a building are placed as three-dimensional objects in a region close to a virtual camera. If the mountains and the rows of houses in a distant view are to be drawn as three-dimensional objects, the amount of data and the operation amount required for drawing will become enormous.

Thus, the programmer places three-dimensional objects, such as a vehicle and a building, and models a three-dimensional space. Along with this process, panorama data PD which represent distant views seen from several coordinates of the three-dimensional coordinate system to be modeled are prepared. Each item of panorama data PD is associated with the coordinate corresponding to the viewpoint and stored in the panorama data storage unit 34.

As the user (hereinafter, referred to as a game user) of a programmed game starts the game and manipulates and moves a vehicle, the camera parameters are changed accordingly moment by moment. The panorama data synthesizing unit 36 synthesizes the panorama data PD based on the camera parameters so as to generate the background data BGD. The rendering part 32 renders the three-dimensional space based on the camera parameters and synthesizes the space with the background data BGD.

According to the image processing apparatus 100 of FIG. 5, the background which feels “right” can be drawn with a smaller operation amount even in a situation where the camera parameters change moment by moment, so that the game user can be immersed in the three-dimensional graphics.

The embodiment is merely illustrative and a variety of techniques are possible to implement the structure and processing steps.

Although a plurality of items of panorama data PDi and PDj (and Pk) are synthesized in the embodiment so as to generate the background data BGD for the background viewed from the camera coordinate Pc, other processes are also possible. For example, when a coordinate for which panorama data PD is provided is located on the line lc passing thorough the camera coordinate Pc and lying in the direction of sight line θ, that panorama data PD may be used as it is, without performing a synthesizing process.

When a coordinate for which panorama data PD is provided is located very close to the camera coordinate, that panorama data may be used. For example, when the distance between the camera coordinate and the coordinate for which the panorama data PD is provided is equal to or smaller than a predetermined value, that panorama data PD may be used. A predetermined threshold may be determined as follows.

1. Given that the distance between the distant view drawn in the panorama data PD and the viewpoint is designated by r, a value obtained by multiplying r by a predetermined ratio is defined as a threshold value. The predetermined ratio is set at several %.

2. Given that the smallest distance between a plurality of coordinates for which the panorama data PD are provided is designated by s, a value obtained by multiplying s by a predetermined ratio is defined as a threshold value.

3. Given that the distance between the camera coordinate and the coordinate associated with panorama data and second closest to the camera coordinate is designated by t, a value obtained by multiplying t by a predetermined ratio is defined as a threshold value.

According to these processes, the synthesizing process becomes unnecessary so that the amount of arithmetic processing can be reduced.

The process for detecting corresponding points in the image data PDi and the image data PDk may not be performed each time but may be performed in advance.

For example, corresponding point information may be calculated between the adjoining items of omnidirectional (360°) image data, which constitute the entire panorama data PD. In this case, drawing is prevented from being delayed due to the matching process when the camera moves at high speed.

According to the described embodiments, interpolation is used. In that process, internal division of an interval between the coordinates Pi and Pj by a line lc is utilized. In an alternative approach, the ratio of the distance between the coordinate Pi and the line lc and with respect to the distance between the coordinate Pj and the line lc may be utilized.

In a further alternative, extrapolation may be used instead of interpolation. Extrapolation is particularly useful when the panorama data PD is located only in one of the regions RGN1 and RGN2, which include the camera coordinate Pc and which are partitioned by the line lc oriented in the direction of sight line θ.

While this invention has been described with reference to preferred embodiments, the embodiments are to be considered as an exemplification of the principles and applications of the invention. Many variations and modifications to arrangement may be made without departing from the spirit of the invention as defined in the claims.

What is claimed is:

1. An image processing method adapted to three-dimensional graphics, comprising:
associating a plurality of coordinates in a three-dimensional space with a plurality of items of panorama data representing distant views as viewed from the respective coordinates; and
when a virtual camera is located at a coordinate not associated with the panorama data, generating background data representing a distant view as viewed from a camera coordinate by synthesizing the panorama data by image matching.

2. The image processing method according to claim 1, wherein
the panorama data holds data for a 360° distant view as viewed from the corresponding coordinate, and
denoting the direction of sight line of the camera as θ, where θ indicates a real number, and denoting the viewing angle of the camera as φ, where φ indicates a real number,
the generating comprises:
extracting first image data by clipping first panorama data so as to include the viewing angle φ around the direction θ;
extracting second image data by clipping second panorama data so as to include the viewing angle φ around the direction θ;
computing matching between the first and second image data;
generating interpolation image data between the first and second image data on the basis of the result of matching; and
outputting the interpolation image thus generated as the background data.

2. The image processing method according to claim 1, wherein
the generating comprises:
selecting coordinates from two regions partitioned by a line which passes through the camera coordinate and which includes the direction of sight line of the camera, and synthesizing the two items of panorama data associated with the selected coordinates.

4. The image processing method according to claim 1, wherein
the generating comprises:
selecting m coordinates forming a m-side polygon, where m is an integer equal to or larger than 3, which includes the camera coordinate; and
synthesizing m items of panorama data associated with the selected coordinates.

5. An image processing apparatus comprising:
a panorama data storage unit which holds a plurality of items of panorama data associated with a plurality of coordinates in a three-dimensional space and representing distant views as viewed from the corresponding coordinate;
a panorama data synthesizing unit which, when a virtual camera is located at a coordinate not associated with the panorama data, generates background data representing a distant view as viewed from a camera coordinate by synthesizing the panorama data; and
a rendering unit which renders a three-dimensional object, placed in the three-dimensional space, along with the background data.

6. A computer program product adapted to draw three-dimensional graphics, comprising:
a module which stores, in a storage area, a plurality of items of panorama data associated with a plurality of coordinates in a three-dimensional space and representing distant view as viewed from the respective coordinates;
a module which acquires a camera coordinate;
a module which reads at least two items of panorama data from the storage area, when the camera coordinate thus read is a coordinate not associated with the panorama data;
a module which uses an arithmetic processor to generate background data representing a distant view as viewed from the camera coordinate by synthesizing the panorama data thus read; and
a module which uses the arithmetic processor to render a three-dimensional object, placed in the three-dimensional space, along with the background data.

7. The computer program product according to claim 6, the product being provided as a plug-in module for a three-dimensional graphics program.
